(19) United States
(12) Patent Application Publication
(10) Pub. No.: US 2024/0325972 A1
(43) Pub. Date: Oct. 3, 2024

(54) CARBON DIOXIDE TREATMENT DEVICE AND CARBON DIOXIDE TREATMENT METHOD

(71) Applicant: HONDA MOTOR CO., LTD., Tokyo (JP)

(72) Inventor: Hiroshi Oikawa, Wako-shi (JP)

(21) Appl. No.: 18/588,062

(22) Filed: Feb. 27, 2024

(30) Foreign Application Priority Data
Mar. 31, 2023 (JP) 2023-056961

(51) Int. Cl. B01D 53/32; B01D 53/14; B01D 53/62

(52) U.S. Cl. CPC B01D 53/326; B01D 53/1475; B01D 53/62; B01D 2256/20; B01D 2257/504

(57) ABSTRACT

The present application aims to reduce energy consumption when collecting carbon dioxide and improve reaction efficiency when electrochemically reducing carbon dioxide. The present invention provides a carbon dioxide treatment device, including an absorption device that absorbs carbon dioxide, a removal device that removes air components from an electrolytic solution containing the carbon dioxide absorbed by the absorption device, an electrochemical reaction part having an electrolysis cell that electrochemically reduces the carbon dioxide absorbed by the absorption device to carbon monoxide, and a solar power generation device that supplies electric power to the electrochemical reaction part.

### BACKGROUND OF THE INVENTION

### Field of the Invention

The present invention relates to a carbon dioxide treatment device, and a carbon dioxide treatment method.

### Description of Related Art

Conventionally, techniques for obtaining valuable materials by collecting carbon dioxide in exhaust gas or the atmosphere and electrochemically reducing the carbon dioxide are known. These techniques are promising techniques capable of achieving carbon neutrality, but economic efficiency is the biggest challenge. In order to improve the economic efficiency, it is important to increase the energy efficiency and decrease the loss of carbon dioxide in the collection and reduction of carbon dioxide.

As a technique for collecting carbon dioxide, a technique is known in which carbon dioxide in a gas state is physically or chemically absorbed to a solid or liquid absorbent, then, detached with energy such as heat and used. In addition, as a technique for electrochemically reducing carbon dioxide, a technique is known in which carbon dioxide gas is supplied to a cathode, in which a catalyst layer is formed on a side of a gas diffusion layer in contact with an electrolytic solution using a carbon dioxide reduction catalyst, from a side opposite to the catalyst layer of the gas diffusion layer and electrochemically reduced (for example, refer to Patent Document 1).

Conventionally, regarding the technique for collecting carbon dioxide and the technique for electrochemically reducing carbon dioxide, research and development has been underway separately. Therefore, in the case of combining each technique, the comprehensive energy efficiency or carbon dioxide loss decrease effect can be determined in a multiplier fashion from the efficiency of each technique, but there is room for additional improvement. As described above, it can be said that it is meaningful to increase the energy efficiency or the carbon dioxide loss decrease effect from a comprehensive viewpoint of combining the technique for collecting carbon dioxide and the technique for electrochemically reducing carbon dioxide.

### PATENT DOCUMENTS

[Patent Document 1] PCT International Publication No. WO 2018/232515

### SUMMARY OF THE INVENTION

Meanwhile, in the technique for electrochemically reducing carbon dioxide, many of the technologies that electrochemically reduce carbon dioxide require a large amount of energy to obtain highly concentrated carbon dioxide when collecting the carbon dioxide, and reducing energy consumption is a major issue. Furthermore, if air components (nitrogen, oxygen) are included in the electrolytic solution supplied for electrochemical reduction of carbon dioxide, there is a problem in that the reaction efficiency decreases when carbon dioxide is electrochemically reduced.

In order to solve the above problems, the present application aims to reduce energy consumption when collecting carbon dioxide and improve reaction efficiency when electrochemically reducing carbon dioxide. In addition, the present application contributes to an increase in the energy efficiency.

[1] A carbon dioxide treatment device, including an absorption device that absorbs carbon dioxide, a removal device that removes air components from an electrolytic solution containing the carbon dioxide absorbed by the absorption device, an electrochemical reaction part having an electrolysis cell that electrochemically reduces the carbon dioxide absorbed by the absorption device to carbon monoxide, and a solar power generation device that supplies electric power to the electrochemical reaction part.

The carbon dioxide treatment device of the present invention includes the removal device that removes air components from the electrolytic solution containing the carbon dioxide absorbed by the absorption device, so that the reaction efficiency when reducing carbon dioxide electrochemically can be improved. In addition, since the carbon dioxide treatment device of the present invention includes the solar power generation device that supplies electric power to the electrochemical reaction part, the solar power generation device can supply the electric power required for electrochemical reduction of carbon dioxide in the electrolysis cell during the day, and as a result, energy consumption when collecting carbon dioxide can be reduced.

[2] The absorption device according to [1], in which the absorption device includes a carbon dioxide absorption part that dissolves and absorbs carbon dioxide in a strong alkaline electrolytic solution, and
the carbon dioxide dissolved in the electrolytic solution in the carbon dioxide absorption part is supplied to the electrochemical reaction part.

Since the carbon dioxide treatment device of the present invention includes the carbon dioxide absorption part, and the carbon dioxide dissolved in the electrolytic solution in the carbon dioxide absorption part is supplied to the electrochemical reaction part, the concentration of carbon dioxide can be accelerated.

[3] The carbon dioxide treatment device according to [1] or [2], in which the electrolysis cell includes a cathode, an anode, an ion exchange membrane provided between the cathode and the anode, a cathode-side liquid flow path that is provided adjacent to the cathode and through which the electrolytic solution containing the dissolved carbon dioxide flows, and an anode-side liquid flow path that is provided adjacent to the anode and through which the electrolytic solution flows.

In the carbon dioxide treatment device of the present invention, carbon dioxide is electrochemically reduced to carbon monoxide with the electrolysis cell.

[4] A carbon dioxide treatment method for electrochemically reducing carbon dioxide, the method including:
a first step of collecting carbon dioxide at all times using electric power transmitted from power plants including nighttime electric power;
a second step of bringing the carbon dioxide collected in the first step into contact with an electrolytic solution containing a strong alkaline aqueous solution, and dissolving and absorbing the carbon dioxide in the electrolytic solution;
a third step of removing air components contained in the electrolytic solution containing carbon dioxide absorbed in the second step; and
a fourth step of electrochemically reducing the carbon dioxide to carbon monoxide using an electrolysis cell with daytime electric power and electric power generated by a solar power generation device.

Since the carbon dioxide treatment method of the present invention constantly collects carbon dioxide using electric power transmitted from a power plant including nighttime electric power, it takes a long time to collect carbon dioxide, and the amount collected thereof can be increased. In addition, since the electrolysis cell electrochemically reduces carbon dioxide to carbon monoxide using daytime electric power and electric power generated by the solar power generation device, it is possible to reduce energy consumption when reducing carbon dioxide. Furthermore, since the air components contained in the electrolytic solution containing carbon dioxide collected in the first step are removed, the reaction efficiency when electrochemically reducing carbon dioxide can be improved.

According to the present invention, it is possible to reduce the energy consumption when collecting carbon dioxide and improve the reaction efficiency when electrochemically reducing carbon dioxide.

### BRIEF DESCRIPTION OF THE DRAWINGS

FIG. 1 is a schematic view illustrating a carbon dioxide treatment device according to an embodiment of the present invention.

### DETAILED DESCRIPTION OF THE INVENTION

Hereinafter, embodiments of the present invention will be described in detail with reference to drawings.

### [Carbon Dioxide Treatment Device]

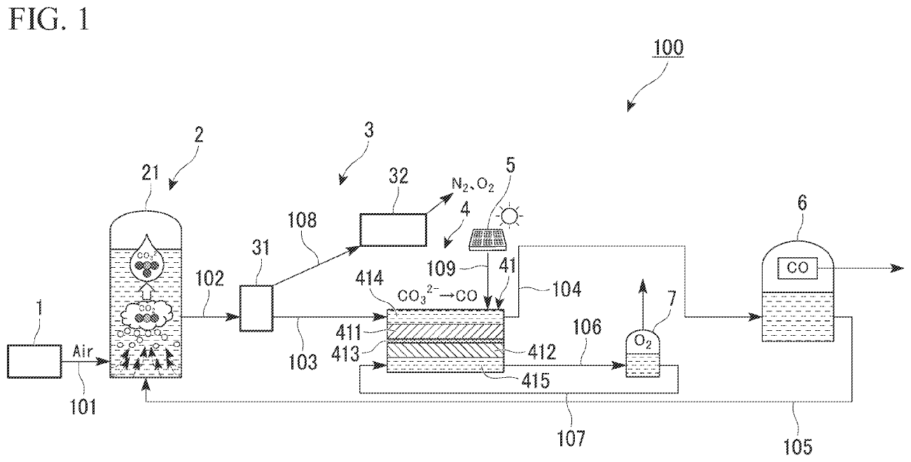

FIG. 1 is a schematic view illustrating a carbon dioxide treatment device 100 according to an embodiment of the present invention. As illustrated in FIG. 1, the carbon dioxide treatment device 100 according to the embodiment of the present invention includes a CO₂ collection device 1, an absorption device 2, a removal device 3, an electrochemical reaction part 4, a solar power generation device 5, a gas-liquid separation part 6, and an oxygen separation part 7.

The absorption device 2 includes a CO₂ absorption part 21.

The removal device 3 includes a negative pressure chamber 31 and a pressure reducing device 32.

The electrochemical reaction part 4 includes an electrolysis cell 41.

In the carbon dioxide treatment device 100, the CO₂ collection device 1 and the CO₂ absorption part 21 are connected to each other through a gas flow path 101. The CO₂ absorption part 21 and the negative pressure chamber 31 are connected to each other through a liquid flow path 102. The negative pressure chamber 31 and the electrochemical reaction part 4 are connected to each other through a liquid flow path 103. The electrochemical reaction part 4 and the gas-liquid separation part 6 are connected to each other through a liquid flow path 104. The gas-liquid separation part 6 and the CO₂ absorption part 21 are connected to each other through a liquid flow path 105. The electrochemical reaction part 4 and the oxygen separation part 7 are connected to each other through liquid flow paths 106 and 107. The negative pressure chamber 31 and the pressure reducing device 32 are connected to each other through a gas flow path 108. The electrochemical reaction part 4 and the solar power generation device 5 are connected to each other through a power line 109.

Each of the above-described flow paths is not particularly limited, and a well-known pipe or the like can be used as appropriate. In the gas flow paths 101 and 108, air supply means such as a compressor, a valve, measuring equipment such as a flow rate meter or the like can be installed as appropriate. In addition, in the liquid flow paths 102, 103, 104, 105, 106 and 107, liquid-feeding means such as a pump, a valve, measuring equipment such as a flow rate meter or the like can be installed as appropriate.

The collection device (Air Contacto) 1 collects carbon dioxide in the atmosphere.

The absorption device 2 absorbs carbon dioxide supplied from the CO₂ collection device 1. To the CO₂ absorption part 21, a gas containing carbon dioxide such as air or exhaust gas is supplied. In the CO₂ absorption part 21, carbon dioxide gas in the gas comes into contact with an electrolytic solution, and carbon dioxide is dissolved and absorbed in the electrolytic solution. Means for bringing the carbon dioxide gas and the electrolytic solution into contact with each other is not particularly limited, and, for example, a method for bubbling by blowing the gas into the electrolytic solution can be exemplified. The carbon dioxide collected with the CO₂ collection device 1 is fed to the CO₂ absorption part 21 through the gas flow path 101.

In the CO₂ absorption part 21, as an absorption liquid that absorbs carbon dioxide, an electrolytic solution composed of a strong alkaline aqueous solution is used. In carbon dioxide, the oxygen atoms strongly attract electrons, and the carbon atoms thus have positive charges (δ+). Therefore, in a strong alkaline aqueous solution where a large number of hydroxide ions are present, the dissolution reaction of carbon dioxide from a hydration state to CO₃²⁻ through HCO₃⁻ proceeds easily, and an equilibrium state where the abundance ratio of CO₃²⁻ is high is formed. This makes it easy for carbon dioxide to dissolve in a strong alkaline aqueous solution compared with other gases such as nitrogen, hydrogen and oxygen and makes the carbon dioxide in the gas be selectively absorbed in the electrolytic solution in the CO₂ absorption part 21. As described above, the use of the electrolytic solution in the CO₂ absorption part 21 makes it possible to accelerate the concentration of carbon dioxide.

The electrolytic solution in which the carbon dioxide has been absorbed in the CO₂ absorption part 21 is fed to the electrochemical reaction part 4 through the liquid flow path 102, and the negative pressure chamber 31.

As the strong alkaline aqueous solution that is used for the electrolytic solution, a potassium hydroxide aqueous solution and a sodium hydroxide aqueous solution can be exemplified. Of the two, a potassium hydroxide aqueous solution is preferably used from the viewpoint of having excellent properties of dissolving carbon dioxide in the CO₂ absorption part 21 and accelerating of the reduction of carbon dioxide in the electrochemical reaction part 4.

The electrochemical reaction part 4 includes the electrolysis cell 41 as an electrolysis cell. In the electrochemical reaction part 4, carbon dioxide is electrochemically reduced with the electrolysis cell 41. In more detail, in the electrochemical reaction part 4, in a reaction path of obtaining ethylene as a desired product by the electrochemical reduction reaction of carbon dioxide, a reduction reaction of carbon dioxide to carbon monoxide is carried out. While one electrolysis cell is illustrated in FIG. 1, the electrochemical reaction part 4 preferably includes an electrolysis cell stack configured by laminating a plurality of electrolysis cells each provided with the electrolysis cell 41.

As illustrated in FIG. 1, the electrolysis cell 41 includes a cathode 411, an anode 412, an ion exchange membrane 413, a cathode-side liquid flow path structure 414 that forms a cathode-side liquid flow path, and an anode-side liquid flow path structure 415 that forms an anode-side liquid flow path.

In the electrolysis cell 41, the cathode-side liquid flow path structure 414, the cathode 411, the ion exchange membrane 413, the anode 412, and the anode-side liquid flow path structure 415 are laminated in this order. In addition, the cathode-side liquid flow path is formed between the cathode 411 and the cathode-side liquid flow path structure 414, and the anode-side liquid flow path is formed between the anode 412 and the anode-side liquid flow path structure 415. The cathode-side liquid flow path and the anode-side liquid flow path are provided at positions facing each other across the cathode 411, the ion exchange membrane 413 and the anode 412. The number of each of the cathode-side liquid flow path and the anode-side liquid flow path provided is preferably plural, and the shape thereof may be a linear shape or a zigzag shape. Further, a power feeder is provided on the surface of the cathode-side liquid flow path structure 414 opposite to the cathode 411. Further, a power feeder is provided on the surface of the anode-side liquid flow path structure 415 opposite to the anode 412.

The power feeder is electrically connected to an electric energy storage part, not illustrated. In addition, the cathode-side liquid flow path structure 414 and the anode-side liquid flow path structure 415 are both conductors and are configured to be capable of applying a voltage between the cathode 411 and the anode 412 with power that is supplied from the electric energy storage part.

The cathode 411 is an electrode that reduces carbon dioxide. In more detail, the cathode 411 in the electrolysis cell 41 mainly reduces carbon dioxide to carbon monoxide. Here, part of the generated carbon monoxide may be reduced to ethylene.

As the cathode 411, for example, an electrode including a gas diffusion layer and a cathode catalyst layer formed on the cathode-side liquid flow path side of the gas diffusion layer can be exemplified. The cathode catalyst layer may be disposed to be partially inserted into the gas diffusion layer. In addition, a porous layer that is denser than the gas diffusion layer may be disposed between the gas diffusion layer and the cathode catalyst layer.

As a cathode catalyst that forms the cathode catalyst layer, a well-known catalyst that is used for the reduction reaction of carbon dioxide can be used. Specific examples of the cathode catalyst include metals such as gold, silver, copper, platinum, palladium, nickel, cobalt, iron, manganese, titanium, cadmium, zinc, indium, gallium, lead and tin, alloys and intermetallic compounds thereof and metal complexes such as a ruthenium complex and a rhenium complex. Among them, examples of a preferable cathode catalyst for the reduction reaction of carbon dioxide to carbon monoxide include silver, gold and zinc. One cathode catalyst may be singly used or two or more cathode catalysts may be jointly used. As the cathode catalyst, a supported catalyst containing metal particles supported by a carbon material (carbon particles, carbon nanotubes, graphene or the like) may also be used.

The gas diffusion layer in the cathode 411 is not particularly limited, and, for example, carbon paper and carbon cloth can be exemplified. A method for producing the cathode 411 is not particularly limited, and examples thereof include a method in which a slurry of a liquid composition containing the cathode catalyst is applied and dried on the surface of the gas diffusion layer that is to be on the cathode-side liquid flow path side.

The anode 412 is an electrode that oxidizes hydroxide ions to generate oxygen. As the anode 412, for example, an electrode including a gas diffusion layer and an anode catalyst layer formed on the anode-side liquid flow path side of the gas diffusion layer can be exemplified. The anode catalyst layer may be disposed to be partially inserted into the gas diffusion layer. In addition, a porous layer that is denser than the gas diffusion layer may be disposed between the gas diffusion layer and the anode catalyst layer.

An anode catalyst that forms the anode catalyst layer is not particularly limited, and a well-known anode catalyst can be used. Specific examples thereof include metals such as platinum, palladium and nickel, alloys and intermetallic compounds thereof, metal oxides such as manganese oxide, iridium oxide, nickel oxide, cobalt oxide, iron oxide, tin oxide, indium oxide, ruthenium oxide, lithium oxide and lanthanum oxide and metal complexes such as a ruthenium complex and a rhenium complex. One anode catalyst may be singly used or two or more anode catalysts may be jointly used.

As the gas diffusion layer in the anode 412, for example, carbon paper and carbon cloth can be exemplified. In addition, as the gas diffusion layer, a porous body such as a mesh material, a punching material, a porous body or a metal fiber sintered body may also be used. As the material of the porous body, for example, metals such as titanium, nickel and iron and alloys thereof (for example, SUS) can be exemplified.

As the material of the cathode-side liquid flow path structure 414 and the anode-side liquid flow path structure 415, for example, metals such as titanium and SUS and carbon can be exemplified.

The negative pressure chamber 31 includes a space for temporarily storing an electrolytic solution containing carbon dioxide fed through the liquid flow path 102 from the CO₂ absorption part 21.

The pressure reducing device 32 reduces the pressure (negative pressure) in the negative pressure chamber 31 and removes air components other than carbon dioxide (nitrogen, oxygen) contained in the electrolytic solution temporarily stored in the negative pressure chamber 31. As the pressure reducing device 32, for example, a vacuum pump is used.

The solar power generation device 5 includes a solar cell that receives sunlight and generates electric power. The electric power obtained by the solar power generation device 5 is supplied to the electrolysis cell 41 to electrochemically reduce carbon dioxide to carbon monoxide.

The gas-liquid separation part 6 separates carbon monoxide from the electrolytic solution containing the carbon monoxide generated with the electrolysis cell 41 in the electrochemical reaction part 4 to collect carbon monoxide.

The oxygen separation part 7 separates oxygen from the electrolytic solution containing the oxygen generated with the electrolysis cell 41 in the electrochemical reaction part 4 to collect oxygen.

The reduction reaction of carbon dioxide with the electrolysis cell 41 will be described.

The first electrolysis cell 41 is a flow cell where the electrolytic solution that is supplied from the CO₂ absorption part 21 and fed through the liquid flow path 102, the negative pressure chamber 3, and the liquid flow path 103, flows into the cathode-side liquid flow path. When a voltage is applied to the cathode 411 and the anode 412, dissolved carbon dioxide in the electrolytic solution that flows through the cathode-side liquid flow path is electrochemically reduced in the cathode 411. The electrolytic solution at the inlet of the cathode-side liquid flow path contains dissolved carbon dioxide and thus has a relatively high abundance ratio of CO₃²⁻ and is in a weak alkaline state. On the other hand, as the electrolytic solution flows through the cathode-side liquid flow path and the reduction proceeds, the amount of the dissolved carbon dioxide, that is, the amount of CO₃²⁻ in the electrolytic solution, decreases, and the electrolytic solution is in a strong alkaline state at the outlet of the cathode-side liquid flow path.

As described above, in the cathode 411 in the electrolysis cell 41, a product that is produced by the reduction of carbon dioxide is mainly carbon monoxide. Specifically, in the cathode 411, a reaction represented by the following cathode half reaction proceeds, and carbon monoxide is thereby generated as a gas-phase product. The generated gas-phase carbon monoxide flows out from the outlet of the cathode-side liquid flow path.

2CO₃²⁻+4H₂O→2CO+8OH⁻ [Cathode half reaction]

Hydroxide ions generated in the cathode 411 in the first electrolysis cell 41 permeate through the ion exchange membrane 413, migrate to the anode 412 and are oxidized by a reaction represented by the following anode half reaction, whereby oxygen is generated. The generated oxygen permeates through the gas diffusion layer of the anode 412, flows into the anode-side liquid flow path and flows out from the outlet of the anode-side liquid flow path.

4OH⁻→O₂+2H₂O [Anode half reaction]

Therefore, in the electrolysis cell 41, as a whole, a reaction represented by the following overall reaction proceeds.

2CO₃²⁻+2H₂O→2CO+O₂+4OH⁻ [Overall reaction]

As described above, in the carbon dioxide treatment device 100 of the present embodiment, the electrolytic solution that is used in the electrochemical reaction part 4 is commonly used as the electrolytic solution in the CO₂ absorption part 21, and carbon dioxide dissolved in the electrolytic solution is supplied to the electrochemical reaction part 4 and electrochemically reduced. This decreases energy necessary for the detachment of carbon dioxide and makes it possible to increase the energy efficiency compared with a case where, for example, carbon dioxide is absorbed to an absorbent, detached by heating and reduced.

Here, as described above, the electrolytic solution at the inlet of the cathode-side liquid flow path contains dissolved carbon dioxide and is thus in a weak alkaline state where the abundance ratio of CO₃²⁻ is high. In contrast, in the reduction reaction of carbon dioxide, since the selective production reaction of ethylene is difficult to proceed under a weak alkaline condition, there is a problem in that the production efficiency of desired ethylene is poor. Therefore, as described above, the gas that flows out from the outlet of the cathode-side liquid flow path in the first electrolysis cell is mainly carbon monoxide.

In contrast, in the carbon dioxide treatment device 100 of the present embodiment, the gas mainly containing carbon monoxide that flows out from the outlet of the cathode-side liquid flow path in the electrolysis cell 41 is collected in the gas-liquid separation part 6. The collected carbon monoxide-based gas is supplied to the production of ethylene.

Since the carbon dioxide treatment device of the present embodiment includes the removal device 3 that removes air components from the electrolytic solution containing carbon dioxide absorbed by the absorption device 2, the reaction efficiency can be improved when the carbon dioxide is electrochemically reduced. In addition, since the carbon dioxide treatment device of the present embodiment includes the solar power generation device 5 that supplies electric power to the electrochemical reaction part 4, the solar power generation device 5 can supply the electric power required for electrochemical reduction of carbon dioxide in the electrolysis cell 41 during the day, and as a result, the amount of energy consumed when collecting carbon dioxide can be reduced.

### [Carbon Dioxide Treatment Method]

A carbon dioxide treatment method according to an embodiment of the present invention is carried out using, for example, the above-described carbon dioxide treatment device 100. Specifically, the carbon dioxide treatment method of the present embodiment preferably includes a step (a) of constantly collecting carbon dioxide using the CO₂ collection device 1 with electric power transmitted from the power plant including nighttime electric power, a step (b) of bringing carbon dioxide gas into contact with an electrolytic solution composed of a strong alkaline aqueous solution in the CO₂ absorption part 21, and dissolving and absorbing carbon dioxide in the electrolytic solution, a step (c) of removing air components contained in the electrolytic solution containing carbon dioxide absorbed by the CO₂ absorption part 21 with the removal device 3, and a step (d) of electrochemically reducing carbon dioxide to carbon monoxide in the electrolysis cell 41 using daytime electric power and electric power generated by the solar power generation device. The carbon dioxide treatment method of the present embodiment can be used in an ethylene production method.

The present invention is not limited to each of the above aspects, and modifications and improvements to an extent that the objective of the present invention can be achieved are included in the present invention.

### EXPLANATION OF REFERENCES

1 CO₂ collection device
2 Absorption device
3 Removal device
4 Electrochemical reaction part
5 Solar power generation device
6 Gas-liquid separation part
7 Oxygen separation part
21 CO₂ absorption part
31 Negative pressure chamber
32 Pressure reducing device
41 Electrolysis cell
100 Carbon dioxide treatment device

What is claimed is:

1. A carbon dioxide treatment device, including an absorption device that absorbs carbon dioxide, a removal device that removes air components from an electrolytic solution containing the carbon dioxide absorbed by the absorption device, an electrochemical reaction part having an electrolysis cell that electrochemically reduces the carbon dioxide absorbed by the absorption device to carbon monoxide, and a solar power generation device that supplies electric power to the electrochemical reaction part.

2. The absorption device according to claim 1, in which the absorption device includes a carbon dioxide absorption part that dissolves and absorbs carbon dioxide in a strong alkaline electrolytic solution, and
the carbon dioxide dissolved in the electrolytic solution in the carbon dioxide absorption part is supplied to the electrochemical reaction part.

3. The carbon dioxide treatment device according to claim 1, in which the electrolysis cell includes a cathode, an anode, an ion exchange membrane provided between the cathode and the anode, a cathode-side liquid flow path that is provided adjacent to the cathode and through which the electrolytic solution containing the dissolved carbon dioxide flows, and an anode-side liquid flow path that is provided adjacent to the anode and through which the electrolytic solution flows.

4. A carbon dioxide treatment method for electrochemically reducing carbon dioxide, the method including:
a first step of collecting carbon dioxide at all times using electric power transmitted from power plants including nighttime electric power;
a second step of bringing the carbon dioxide collected in the first step into contact with an electrolytic solution containing a strong alkaline aqueous solution, and dissolving and absorbing the carbon dioxide in the electrolytic solution;
a third step of removing air components contained in the electrolytic solution containing carbon dioxide absorbed in the second step; and
a fourth step of electrochemically reducing the carbon dioxide to carbon monoxide using an electrolysis cell with daytime electric power and electric power generated by a solar power generation device.
